(19) United States
(12) Patent Application Publication
(10) Pub. No.: US 2026/0125606 A1
(43) Pub. Date: May 7, 2026

(54) PROCESS FOR REMOVING IMPURITIES IN FEEDSTOCKS

(71) Applicant: TOPSOE A/S, Kgs. Lyngby (DK)

(72) Inventors: Christian Frederik WEISE, Kgs. Lyngby (DK); Michal LUTECKI, Kgs. Lyngby (DK); Frank Bartnik JOHANSSON, Kgs. Lyngby (DK)

(73) Assignee: TOPSOE A/S, Kgs. Lyngby (DK)

(21) Appl. No.: 19/117,521

(22) PCT Filed: Oct. 17, 2023
(86) PCT No.: PCT/EP2023/078736

§ 371 Date: Apr. 1, 2025

(30) Foreign Application Priority Data
Oct. 19, 2022 (DK) PA202200943

(51) Int. Cl. C10G 67/02; B01J 21/00; B01J 21/06; B01J 21/10; B01J 35/61; B01J 35/63; B01J 35/66; B01J 37/08; B01J 37/12

(52) U.S. Cl. CPC C10G 67/02; B01J 21/005; B01J 21/063; B01J 21/10; B01J 35/615; B01J 35/635; B01J 35/66; B01J 37/08; B01J 37/12; C10G 2300/202

(57) ABSTRACT

The invention relates to a process and plant for removing one or more impurities from a feedstock, said process comprising the step of contacting said feedstock with a guard bed comprising a porous material, thereby providing a purified feedstock; wherein the porous material comprises at least 80 wt % of magnesium aluminate spinel (MgAl₂O₄), titania (TiO₂), or a mixture thereof; and the porous material has a total pore volume of 0.50-0.90 ml/g, as measured by mercury intrusion porosimetry. The invention envisages also a process and plant in which the guard bed comprises a porous material which is at least 80 wt % SiO₂.

The invention relates to a process and plant for removing one or more impurities, for instance phosphorous (P), from a feedstock such as a renewable feedstock, by contacting the feedstock with a guard bed comprising a porous material, the porous material being: magnesium aluminate spinel (MgAl₂O₄), titania (TiO₂), or a mixture thereof. Optionally, the porous material is silica (SiO₂).

Renewable fuels may be produced from a broad variety of sources including animal fats and vegetable oils but also tall oil, pyrolysis oils and other non-edible compounds. Before feedstocks derived from renewable organic material can be used in conventional automobile engines, aviation turbines, marine engines or other engines, and distributed using existing fuel infrastructure, it is desirable to convert the material into hydrocarbons similar to those present in petroleum-derived transportation fuels. One well-established method for this purpose is the conversion of vegetable oils into normal paraffins in the gasoline, jet fuel or diesel boiling range by employing a hydrotreating process.

In a hydrotreating process, the renewable organic material is reacted with hydrogen at elevated temperature and pressure in a catalytic reactor.

A particular problem with feedstocks such as renewable feedstocks is that they contain impurities such as phosphorus-containing or silicon-containing species. Phosphorus-containing species may take the form of phospholipids such as lecithin, from seed oils. Waste lube oils can also contain species such as zinc dialkyl dithio phosphates (ZDDP), which acts as an anti-wear additive in such lubricants. Phosphorus (P) quickly deactivates conventional catalysts for hydrotreating and reduces cycle length dramatically. The refiners processing renewable feedstocks are forced to load more material for guarding the hydrotreating catalyst compared to fossil fuel-based refining processes. The units often employ pre-treatment of the feedstocks using washing and/or adsorbents to reduce P from 10-20 ppm down to 1-2 ppm, but even at 1-2 ppm, guard materials are needed.

Thus, refiners processing renewables, whether by using only renewables as the feedstock, or a mixture of renewables and fossil fuels i.e. co-processing, uniformly express the need for better guard materials for particularly P capture to prevent pressure drop and deactivation of their bulk catalysts. It is therefore vital to reduce, or—if possible—remove, impurities, particularly phosphorus-containing species before reaching the bulk catalyst.

The concept of “guard beds” for catalytic processes are known. For instance, from U.S. Pat. No. 5,879,642. An upstream catalyst bed functions as a guard catalyst bed for removing a major proportion of impurities from a hydrocarbon feed stream in order to extend the life of one or more catalyst beds located underneath (downstream) the guard catalyst bed.

U.S. Pat. No. 9,447,334 (US 2011/138680) discloses a process for converting feeds derived from renewable sources with pre-treatment of feeds, whereby upstream of the hydrotreatment step, a step for intense pre-treatment for eliminating hetero-elements such as phosphorus which are insoluble under hydrotreatment conditions, is conducted. This step includes the use of an adsorbent free of catalytic material (free of catalytic metals), having a high surface area e.g. 140 m²/g and high total pore volume e.g. 1.2 ml/g.

US 2004/077737 discloses a catalyst for use for Fischer-Tropsch synthesis which comprises 3-35 wt % cobalt supported on alumina, the alumina support having a surface area of <50 m²/g and/or is at least 10% alpha-alumina. The cobalt (Co) is suitably combined with the metal promoters Re or Pt. In particular, where Co is promoted with Re or Pt, the content of Co in the catalyst is 5 wt % or higher. When using only Co in the catalyst, its content is 12 wt % or higher.

U.S. Pat. No. 4,510,092 discloses a method of continuously hydrogenating fatty materials, in particular liquid vegetable oils, over a nickel on alpha-alumina catalyst whose surface area is <10 m²/g, the micropore volume is <0.1 ml/g and the macropore volume is <0.6 ml/g, preferably <0.3 ml/g. By micropore volume is meant the total volume of pores under about 117 Å in size; while by macropore volume is meant the total volume of pores greater than about 117 Å in size. The nickel content is high, namely 1-25%.

U.S. Pat. No. 4,587,012 discloses a process for upgrading a hydrocarbonaceous stream for removing the metal impurities nickel, vanadium and iron, using a catalyst which comprises more than 80% alpha-alumina. The catalyst material has a pore volume (PV) of only about 500 ml/kg (0.5 ml/g) and no more than 10% macropores, i.e. there is no more than 10% of PV being in pores with radius >500 Å (diam. >1000 Å).

Conventional and commercially available guard bed materials used for P capture are in the form of a catalyst made of high pore volume gamma-alumina carrier with low metal content for hydrotreating activity.

Often, the use of metals in the guard material, particularly metals having hydrotreating activity such as Mo or Ni, results in undesired coking, which translates into plugging of the guard bed and thereby inexpedient pressure drop. Too high activity reached by high metals or promotion leads to coking due to hydrogen starvation around the catalyst and high temperature due to exotherms.

Applicant's WO 2022008508 discloses a phosphorous guard bed for a hydrotreatment system, the phosphorous guard bed comprising a porous material, the porous material comprising alpha-alumina and optionally one or more metals selected from Co, Mo, Ni, W and combinations thereof.

Despite recent progress in the field, there is a need for additional materials, in particular porous materials for use in guard beds for removing of impurities such as P while at the same time reducing the level of coking in the porous material, in particular also for feedstocks comprising a significant portion of renewables including a feedstock with 100% renewables, i.e. a 100% renewable feed.

Hence, in a first general embodiment according to a first aspect of the invention, there is provided a process for removing one or more impurities from a feedstock, said process comprising the step of contacting said feedstock with a guard bed comprising a porous material, thereby providing a purified feedstock; wherein the porous material comprises at least 80 wt % of: magnesium aluminate spinel (MgAl₂O₄), titania (TiO₂), or a mixture thereof; and the porous material has a total pore volume of 0.50-0.90 ml/g, as measured by mercury intrusion porosimetry.

The mercury intrusion porosimetry is conducted according to ASTM D4284.

It has been found that these porous materials provide a significant P-capture in renewable feedstocks, while at the same time limiting the coking of the porous materials to acceptable levels.

Furthermore, there is a prolonged lifecycle of the hydroprocessing units of process or plant.

As used herein, the term “comprising” includes also “comprising only” i.e. “consisting of”.

As used herein, the term “suitably” means “optionally” i.e. an optional embodiment.

As used herein, the term “invention” or “present invention” are used interchangeably with “application” or “present application”, respectively.

As used herein, the term “first aspect” or “first aspect of the invention” refer to the process according to the invention. The term “second aspect” or “second aspect of the invention” refers to a plant (system) according to the invention.

Other definitions are provided throughout the application in connection with embodiments of the invention.

Suitably, the porous material comprises at least 90 wt % or at least 95 wt %, such as 96 wt %, 97 wt %, 98 or 98.5 wt %, 99 or 99.5 wt % or 100 wt % of: MgAl₂O₄. Thus, in an embodiment, the porous material may also be high purity MgAl₂O₄.

As used herein, the term “high purity” means at least 98.5 wt %, such as 99 wt %, 99.5 wt %, or 100 wt %.

The balance (up to 100 wt %) of the porous material may be provided by an additive, such as silica (SiO₂). For instance, ≥80 wt % of the porous material is MgAl₂O₄ and ≤20 wt % is an additive such as SiO₂. For instance, ≥80 wt % of the porous material is TiO₂ and ≤20 wt % is an additive such as SiO₂. For instance, ≥80 wt % of the porous material is a mixture of MgAl₂O₄ and TiO₂, and ≤20 wt % is an additive such as SiO₂.

It would be understood that the term “additive” means a material in the process material other than any of MgAl₂O₄ and/or TiO₂, and which is used as the balance (up to 100 wt %) of the porous material. Thus, an additive, such one or more additives, represent ≤20 wt % of the porous material.

An additive, such as SiO₂, provides stability of the porous material, i.e. less sensitivity to operation temperatures of the process, these being e.g. 100-400° C., optionally in the presence of a reducing agent such as hydrogen. In addition, the provision of e.g. SiO₂ may enable reducing the costs of the porous material and thereby the process, as the additive, e.g. SiO₂, may often be less expensive than MgAl₂O₄ and/or TiO₂.

Suitably, the porous material comprises at least 90 wt % or at least 95 wt %, such as 96 wt %, 97 wt %, 98 or 98.5 wt %, 99 or 99.5 wt % or 100 wt % of TiO₂. Thus, in an embodiment, the porous material may also be high purity TiO₂, such as 100 wt % anatase.

In an embodiment, the porous material is 100 wt % of said mixture of MgAl₂O₄ and TiO₂.

In an embodiment, said mixture of MgAl₂O₄ and TiO₂ is 30-70 wt % MgAl₂O₄ and 70-30 wt % TiO₂. Accordingly, the ratio by mass of MgAl₂O₄ to TiO₂ is from 30:70 to 70:30.

For instance, the porous material is 100 wt % of a mixture of MgAl₂O₄ and TiO₂, as 30-70 wt % MgAl₂O₄ and 70-30 wt % TiO₂. For instance, the porous material is 50 wt % of high purity MgAl₂O₄ and 50 wt % of high purity TiO₂. For instance, the porous material is 35 wt % of high purity MgAl₂O₄ and 65 wt % of high purity TiO₂.

A mixture of MgAl₂O₄ and TiO₂, such as 100 wt % mixture of MgAl₂O₄ and TiO₂ as said 30-70 wt % MgAl₂O₄ and 70-30 wt % TiO₂, in which the MgAl₂O₄ and TiO₂ are prepared or provided as recited above, enables also a high P-capture.

The porous material comprising at least 80 wt % MgAl₂O₄ may for instance be externally sourced as MgAl₂O₄ powder, or as particles such as pellets e.g. tabletized pellets for instance having a tetralobal shape. The MgAl₂O₄ powder may e.g. contain 99.5% MgAl₂O₄, i.e. a high purity MgAl₂O₄. The porous material comprising at least 80 wt % TiO₂ may for instance be externally sourced as TiO₂ powder, or as particles such as pellets e.g. tabletized pellets for instance having a tetralobal shape. The TiO₂ powder may e.g. contain 99.5% TiO₂, i.e. a high purity TiO₂.

Suitably, the process further comprises a prior step for preparing the porous material, by providing a starting material, i.e. a precursor material, comprising MgAl₂O₄ and subjecting it to calcination in air at 850-1050° C., such as 900-1000° C., e.g. 900, 950 or 1000° C., optionally for 1-3 hrs such as 2 hrs.

Suitably, the starting material is high purity MgAl₂O₄, for instance as said externally sourced MgAl₂O₄ powder, or as particles such as pellets e.g. tabletized pellets for instance having a tetralobal shape.

It has been found that, for MgAl₂O₄, where the calcination temperature is below 800° C., the total pore volume (PV) becomes too high, i.e. higher than 0.90 ml/g (>900 ml/kg), while where the calcination temperature is above 1050° C., the PV becomes too low, i.e. lower than 0.5 ml/g (<500 ml/kg). Outside the 500-900 ml/kg, low P-capture is observed.

Suitably, the process comprises providing a starting material directly as said MgAl₂O₄.

By “directly” is meant that there is no prior step of calcination or heat treatment for providing said MgAl₂O₄.

Suitably, the process further comprises a prior step for preparing the porous material, by providing a starting material, i.e. precursor material, comprising TiO₂ and subjecting it to calcination in air to below 500° C., such as 250-450° C., e.g. 300, 350 or 400° C. optionally for 1-3 hrs such as 2 hrs.

Suitably, the process comprises providing a starting material directly as TiO₂.

By “directly” is meant that there is no prior step of calcination or heat treatment for providing said TiO₂.

Hence, the process may comprise providing a starting material directly as said MgAl₂O₄, TiO₂, or mixture thereof.

Again, by “directly” is meant that there is no prior step of calcination or heat treatment for providing said MgAl₂O₄, TiO₂, or mixture thereof.

As used herein, the term “starting material”, or interchangeably “precursor material”, applies for MgAl₂O₄ or TiO₂ or a mixture thereof.

For MgAl₂O₄, the term “starting material” is the material, for instance MgAl₂O₄ powder or MgAl₂O₄ particles, which is e.g. externally sourced, and that following its calcination in air at 850-1050° C., such as 900, 950 or 1000° C., optionally for 1-3 hrs such as 2 hrs, becomes the MgAl₂O₄ that is provided as said at least 80 wt % of the porous material of the guard bed. The starting material may also be provided directly as said at least 80 wt % of the porous material of the guard bed, without conducting said calcination or a heat treatment.

For TiO₂, the term “starting material” is the material, for instance TiO₂ powder or TiO₂ particles, which is e.g. externally sourced, and that following its calcination in air at below 500° C., such as 250-450° C., optionally for 1-3 hrs such as 2 hrs, becomes the TiO₂ that is provided as said at least 80 wt % of the porous material of the guard bed. The starting material may also be provided directly as said at least 80 wt % of the porous material of the guard bed, without conducting said calcination or a heat treatment.

It has been found that, for TiO₂, calcination at low temperatures, i.e. below 500° C. or no calcination or heat treatment, provides a PV of 0.50 ml/g or higher, such as 600, 700 ml/g, thus advantageous for P-capture. Contrary to MgAl₂O₄, increasing the calcination temperature for TiO₂ to above 500° C. results in PV lower than 0.50 ml/g. For instance, calcination in air at 550° C. for 2 hrs results in a PV of 0.44 ml/g; calcination in air at 750° C. for 2 hrs results in PV of 0.240 ml/g. At these low values of PV (below 0.50 ml/g) low P-capture is observed.

Accordingly, more specifically, in an embodiment the process further comprises:
i-1) a prior step for preparing the MgAl₂O₄ of said porous material by providing a starting material comprising MgAl₂O₄ and subjecting it to calcination in air at 850-1050° C., such as 900-1000° C., e.g. 900, 950 or 1000° C., optionally for 1-3 hrs such as 2 hrs;
or
i-2) providing a starting material directly as said MgAl₂O₄;
and/or
ii-1) a prior step for preparing the TiO₂ of said porous material by providing a starting material comprising TiO₂ and subjecting it to calcination in air to below 500° C., such as 250-450° C., e.g. 300, 350 or 400° C., optionally for 1-3 hrs such as 2 hrs;
or
ii-2) providing a starting material directly as said TiO₂.

In particular, where in step i-1) said calcination is at 900-1000° C. and step i-2) it is below 500° C. or obviated, the best P-captures are observed, as shown in the Examples section farther below.

In an embodiment, the titania (TiO₂) is at least 99.9 wt % anatase. It has been found that at ≤99.8 wt % anatase, for instance where the TiO₂ is 99.8 wt % anatase and 0.2 wt % rutile, the pore volume becomes too low (below 0.50 ml/g) for proper P-capture. For instance, when calcining TiO₂ starting material in air at above 600° C. for 1-3 hrs, such as 2 hrs, TiO₂ as rutile appears and becomes 0.2 wt % or more of the TiO₂. For instance, calcination at 650° C. for 2 hrs results in 0.2 wt % rutile and pore volume of 0.390 ml/g; and calcination at 750° C. for 2 hrs results in 1.1. wt % rutile and PV of 0.240 ml/g.

In an embodiment, the porous material comprises one or more metals selected from Co, Mo, Ni, W, and combinations thereof; and the content of the one or more metals is 0.25-20 wt %. For instance, the content of the one or more metals is 0.25-15 wt %, 0.25-10 wt %, or 0.25-5 wt %.

Without being bound by any theory, it may appear that by the present application, the surface reactivity of the porous material towards P-species is reduced—so that P is not only captured on the surface of the porous material—compared to conventional gamma-alumina based materials, yet it is at least on par with alpha-alumina materials as disclosed in the above-mentioned applicant's WO 2022008508 (see Examples section). At the same time, the porous material allows for better penetration of the feed, in particular renewable feed, and thereby penetration of P-species. Moreover, it has also been found that the use of one or more metals having hydrotreating activity enable less coking on the porous material, which again, without being bound by any theory, may be attributed to the metal, e.g. Mo, blocking the remaining acidic sites or to some small hydrogenation activity of the porous material when the metal is present.

In an embodiment, the porous material has a BET-surface area of 1-150 m²/g. The BET-surface area is suitably measured according to ASTM D4567-19, i.e. single-point determination of surface area by the BET equation.

It has been found that lowering the BET surface area enables lower coking, particular for TiO₂ and MgAl₂O₄. BET surface areas higher than 150 m²/g result in higher coking.

Suitably, the BET surface area is 60-120 m²/g, for instance 65, 70, 75, 80, 85, 90, 95, 100, 105, 110, 115 m²/g.

In an embodiment, the MgAl₂O₄ of the porous material has a BET surface area of 50-150 m²/g, such as 60, 70, 80, 90, 100, 110, 120, 130, 140 m²/g.

In an embodiment, the TiO₂ of the porous material has a BET surface area of 100-150 m²/g, such as 110, 120, 130, 140 m²/g.

The level of coking, or simply coking, is herein referred to as the content of carbon of the porous material after use.

In an embodiment, the MgAl₂O₄ of the porous material is at least 90 wt % MgAl₂O₄, such as at least 95 wt % MgAl₂O₄, at least 99 wt % MgAl₂O₄, or 100% MgAl₂O₄, and has a pore size distribution (PSD) in which at least 60 vol. %, such as at least 70 vol. % or at least 80 vol. % of the total pore volume is in pores with a radius below 400 Å, such as such as pores with a radius down to 40 Å, or down to 80 Å.

For MgAl₂O₄, the bigger pores with radius equal to or above 400 Å, or equal to or above 500 Å, serve for the P-capture, while the smaller pores with radius below 400 Å enable better use of the one or more metals in the porous material for providing hydrotreating activity. The porous material has e.g. a bimodal pore system, in which particularly the smaller pores (pore radius below 400 Å) add the possibility for providing the hydrotreating activity to the porous material.

In an embodiment, the TiO₂ of the porous material is at least 90 wt % TiO₂, such as at least 95 wt % TiO₂, at least 99 wt % TiO₂, or 100% TiO₂, and has a pore size distribution (PSD) in which at least 90 vol. %, such as at least 95 vol. % of the total pore volume is in pores with a radius below 120 Å, such as pores with a radius down to 40 Å, or down to 80 Å, for instance 80-120 Å; and the average pore size radius is 80-100 Å.

The TiO₂ of the porous material has a unimodal pore system, and surprisingly also, this material with this pore structure predominantly being small pores (average pore size radius of 80-100 Å) enables a P-capture which is at least on par with that of MgAl₂O₄, while at the same time adding the possibility for providing the hydrotreating activity to the porous material. No bigger pores, such as pores with radius above 400 Å or 500 Å appear necessary for P-capture.

The guard material, i.e. the porous material, has some (albeit low) hydrotreating activity to avoid coking and high exothermicity when contacting the feed with the main downstream catalyst bed for hydrotreating. The most reactive molecules in the feed are converted, thereby reducing the risk of excessive temperature rise which can lead to gumming. Hence, by the invention a trade-off is realized: no metals may cause coking in the material; too much metal activity will cause coking and gumming due to too high exotherms. A low metal content, for instance 15 wt % Mo, 10 wt % Mo, 5 wt % Mo, or lower such as 3 wt % Mo, 1 wt % Mo, or 0.5 wt % Mo, suitably in the corresponding ranges as recited below, seems to be just right to balance out these two deactivation effects. Furthermore, some preheating prior to the feed reaching the bulk catalyst, i.e. the downstream hydrotreating catalyst, is also achieved, thereby enabling better energy efficiency of the process or plant.

Accordingly, in an embodiment, the one or more metals comprise Mo and its content is 0.5-15 wt %, such as 0.5-10 wt %, or 0.5-5 wt %, or 0.5-3 wt %, for instance 0.5-1.5 wt % or 0.5-1 wt % such as 0.7 or 0.9 wt %, or 1-2 wt %. Optionally, 0.1-5 wt %, such as 0.1-3 wt %, 0.1-1 wt %, 0.1-0.5 wt %, or 0.1-0.2 wt % of at least one of Ni, Co, and W, is provided. Optionally also, the porous material is free of Co and/or W. For instance, the porous materials comprise 0.05-5 wt % Mo, with Mo thus being the one or more metals. For instance, the porous material comprises 0.5-0.5 wt % Ni. The content of Ni is much lower than conventional materials. Hence, for instance also, the porous material comprises 0.5-5 wt % Mo and 0.05-0.5 wt % Ni, with Mo and Ni thus being the one or more metals.

Accordingly, in an embodiment, the porous material is free of Co and/or W and further comprises 0.05-0.5 wt % Ni.

It would thus be understood, that in a particular embodiment, the at least one or more metals is Mo. In another particular embodiment, the one or more metals are Mo and Ni. Hence, the porous material does not comprise one or more metals selected from Co, W. For instance, the porous material may comprise 0.5-1.5 wt % Mo, such as 1 wt % Mo, and 0.1-0.2 wt % Ni. Due to the low surface area of the pore material, the Mo load (Mo content) is lowered, yet by adding e.g. Ni as promoter, it is possible to compensate for the low metal content. Furthermore, despite of a low surface area of the porous material of the invention, a small amount of molybdenum e.g. 0.5-3 wt % Mo, such as about 1 wt % may result in a significantly lower coke formation.

The present invention does not require the use of any metals to provide for P-capture, yet the addition of Mo turns out to reduce coking significantly and enables also the desired effect of achieving an activity gradient in the unit comprising the porous material anyway. Furthermore, while addition of Co or Ni as a promoter may be desirable since it increases activity dramatically, this may be really detrimental for the downstream hydrotreatment section comprising at least one hydrotreatment catalyst. More specifically, it may be really detrimental for hydrotreatment/hydrodeoxygenation (HDO) selectivity (yield loss) when processing renewable feedstocks. While it is desirable that oxygen removal from the renewable feedstock in the HDO proceeds mainly by removing H₂O, having particularly nickel in amounts higher than about 0.5 wt % results in undesired decarboxylation, thus reducing HDO selectivity.

The material catalytically active in hydrotreating/HDO, typically comprises an active metal (sulfided base metals such as nickel, cobalt, tungsten and/or molybdenum, but possibly also either elemental noble metals such as platinum and/or palladium) and a refractory support (such as alumina, silica or titania, or combinations thereof).

Hydrotreating conditions involve a temperature in the interval 250-400° C., a pressure in the interval 30-150 bar, and a liquid hourly space velocity (LHSV) in the interval 0.1-2, optionally together with intermediate cooling by quenching with cold hydrogen, feed or product.

In an embodiment according to the first aspect, the at least one metal is in the form of oxides or sulfides.

In an embodiment according to the first aspect, the porous material is an extruded or tabletized pellet having a shape selected from trilobal, tetralobal, pentalobal, cylindrical, spherical, hollow such as hollow rings or hollow cylinders, and combinations thereof. Pellets having tetralobal shape, are particularly advantageous, due to improved outer surface area to volume ratio.

In an embodiment, the one or more impurities are selected from a vanadium-containing impurity, silicon-containing impurity, a halide-containing impurity, an iron-containing impurity, a phosphorous-containing impurity, and combinations thereof; preferably, the one or more impurities is a phosphorous (P)-containing impurity. Further, the process is carried out at high temperature such as 100-400° C., for instance 250-350° C., optionally in the presence of a reducing agent such as hydrogen.

In an embodiment, the feedstock is renewable feedstock, a fossil fuel feedstock, or a combination thereof. Suitably, the feedstock is a renewable feedstock or a combination of a renewable feedstock and a fossil fuel feedstock.

Accordingly, in an embodiment, the feedstock is:
i) a renewable source obtained from a raw material of renewable origin, such as originating from plants, algae, animals, fish, vegetable oil refining, domestic waste, waste rich in plastic, industrial organic waste like tall oil or black liquor, or a feedstock derived from one or more oxygenates taken from the group consisting of triglycerides, fatty acids, resin acids, ketones, aldehydes or alcohols where said oxygenates originate from one or more of a biological source, a gasification process, a pyrolysis process, Fischer-Tropsch synthesis, or methanol based synthesis. The oxygenates may also originate from a further synthesis process. Some of these feedstocks may contain aromatics; especially products from pyrolysis processes or waste products from e.g. frying oil. Any combinations of the above feedstocks are also envisaged.

The feedstock can also be:
ii) a feedstock originating from a fossil fuel, such as diesel, kerosene, naphtha, vacuum gas oil (VGO), spent lube oil, or combinations thereof;
or
iii) a feedstock originating from combining a renewable source according to i) and a feedstock originating from a fossil fuel according to ii)

In the context of the present invention, the terms “renewable source” and “renewable feed” or “renewable feedstock”, are used interchangeably. The terms “feedstock originating from a fossil fuel” and “fossil fuel feedstock” are also used interchangeably.

In an embodiment, the portion of the feedstock originating from a renewable source is 5-60 wt %, such as 10 or 50 wt %. In another particular embodiment, the portion of the feedstock originating from a renewable source is higher than 60 wt %, for instance 70-90 wt %.

In an embodiment, the one or more impurities is a phosphorous (P)-containing impurity and said feedstock contains 0.5-1000 ppm P. The content of P may vary significantly depending on feedstock. For instance, 50-60 ppm P in oils derived from oxygenates originated from a pyrolysis process e.g. pyrolysis oil, or 100-300 ppm, or 50-300 ppm e.g. 200 ppm for a feedstock originating from animals, particularly animal fat. For instance also, the content of P is 400, 500, 600, 700, 800, 900 ppm.

It would be understood that the ppm units are on weight basis, i.e. ppm-wt.

In an embodiment, the purified feedstock is subsequently processed in a hydrotreatment stage in the presence of a hydrotreatment catalyst. In a particular embodiment, the hydrotreatment stage is directly downstream with optional heating/cooling in between. In another particular embodiment, the hydrotreatment catalyst preferably comprises at least one metal selected from Co, Mo, Ni, W and combinations thereof.

In a second general embodiment according to the first aspect of the invention, there is provided a process for removing one or more impurities from a feedstock, said process comprising the step of contacting said feedstock with a guard bed comprising a porous material, thereby providing a purified feedstock; wherein the porous material comprises at least 80 wt % of silica (SiO₂), and the porous material has a total pore volume of 0.90-1.50 ml/g, as measured by mercury intrusion porosimetry.

The mercury intrusion porosimetry is conducted according to ASTM D4284.

P-capture is also observed, albeit somewhat lower than for MgAl₂O₄ and TiO₂, while at the same time enabling a coke reduction on par with MgAl₂O₄ and TiO₂, as shown in the Examples section of the present application.

Suitably, the porous material comprises at least 90 wt % or at least 95 wt %, such as 96 wt %, 97 wt %, 98 or 98.5 wt %, 99 or 99.5 wt % or 100 wt % of SiO₂. Thus, in an embodiment, the porous material is high purity SiO₂.

The porous material comprising at least 80 wt % SiO₂ may for instance be externally sourced as silica powder, or as particles as recited above for MgAl₂O₄ and TiO₂. For instance, the silica powder may contain 98.5-99 wt % SiO₂, i.e. high purity SiO₂, with the remaining comprising traces of alumina, titania and iron oxide. For instance also, the silica powder may be silica sand.

In an embodiment, the process further comprises providing a starting i.e. precursor material directly as said SiO₂.

In an embodiment, the porous material comprising at least 80 wt % SiO₂ has a total pore volume of 0.90-1.50 ml/g.

In an embodiment, the porous material has a BET-surface area of 200-350 m²/g, such as 210, 220, 230, 240, 250, 260, 270, 280, 290, 300, 310, 320, 330, 340 m²/g.

In a second aspect of the invention, there is also provided a plant (system) for conducting the process according to any of the above embodiments.

It would be understood that any of the embodiments according to the process of the invention may be used in connection with the plant of the invention, or vice versa.

### EXAMPLES

Table 1 below shows results of porous materials according to the present invention compared with the prior art. Loss of ignition (LOI, wt %) as is well-known in the art, is used to measure the coking of the samples after use and thus as a proxy of carbon content (C, wt %). The total pore volume (PV) of the fresh sample is shown, as so is the P-capture (P-pick up) after use. No metals such as Mo were added. The tests were conducted in batch reactor tests by reacting a small amount of sample in a batch reactor with renewable feed at approximately 300° C. in the presence of hydrogen, as follows:

### Sample Preparation:

Catalyst or carrier samples were crushed and sieved to a size of 300-600 microns.

### Model Feedstock:

For 400 g feedstock, 6.65 g lecithin were dissolved in 197 g heptane after which 197 g of soy bean oil were added. This gives a phosphorous content of 800 ppm-wt.

### Test Procedure:

1.5 g of the sample together with 15 g of feedstock were added to a batch reactor. The reactor was sealed and flushed with nitrogen. After applying 50 bar of hydrogen pressure the reactor was heated to 320° C. (2.5° C./min) and held for 6 min at maximum temperature. After recovery of the sample particles, they were extracted with xylene using a Soxhlet apparatus to remove any heavy oil residues and dried in vacuum at 90° C.

### Analysis:

The dried samples were analyzed for carbon using the LECO instrument and for P and Al by XRF analysis, as disclosed in applicant's WO 2022008508.

The mercury intrusion porosimetry for determining the total pore volume (PV) is conducted according to ASTM D4284.

TABLE 1

| | LOI, | C, | PV | P-capture | BET area, |
|---|---|---|---|---|---|
| Sample | wt % | wt % | (ml/kg) | (g/L) | m²/g |
| A | 12.3 | 8.43 | 804 | 4.53 | 115 |
| B | 8.9 | — | 517 | 7.30 | 131 |
| C | 6.4 | 4.22 | 550 | 5.30 | 66 |
| D (prior art) | 4.3 | 3.07 | 651 | 5.78 (77.7*) | — |
| E | 8 | 5.65 | 1416 | 3.00 | 304 |

A: 100 wt % MgAl₂O₄ after calcination of MgAl₂O₄ catalyst carrier material at 900° C.; B: 100 wt % TiO₂ (anatase) after calcination below 500° C. of TiO₂ catalyst carrier material or no calcination (no heat treatment) - the starting material is provided directly as the TiO₂; C: 100 wt % MgAl₂O₄ after calcination of MgAl₂O₄ catalyst carrier material at 1000° C.; D (prior art): according to applicant's WO 2022008508, i.e. alpha-alumina based sample (sample 3, FIG. 1-2 therein). E: 100% SiO₂ - the starting material is provided directly as SiO₂.
*Note:
77.7 g/L is the P-capture of applicant's WO 2022008508, which is not conducted in batch tests as in the present application, and thus not directly comparable.

The batch reactor tests show that A (100% MgAl₂O₄), B (100 wt % TiO₂) and C (100 wt % MgAl₂O₄), in particular samples B and C, are good candidates for a guard bed, as these are similar or appear even better (sample B) in P-capture compared to sample D. Sample D, showing a P-capture of 5.78 g/L in the present batch tests, and used herein as reference porous material, corresponds to sample 3 FIG. 1-2 of WO 2022008508, being rich in alpha-alumina and comprising also theta-alumina. Sample D showed a high P-capture at industrially relevant conditions of about 600% higher than the reference therein (WO 2022008508, sample 1—ref: >95 wt % gamma-alumina). Sample E (100% SiO₂) shows a somewhat lower P-capture than samples A-C, and a carbon content on par with sample B.

1. A process for removing one or more impurities from a feedstock, said process comprising the step of contacting said feedstock with a guard bed comprising a porous material, thereby providing a purified feedstock;
wherein the porous material comprises at least 80 wt % of: magnesium aluminate spinel (MgAl₂O₄), titania (TiO₂), or a mixture thereof; and the porous material has a total pore volume of 0.50-0.90 ml/g, as measured by mercury intrusion porosimetry.

2. The process according to claim 1, wherein the porous material comprises said mixture of MgAl₂O₄ and TiO₂, said mixture being 30-70 wt % MgAl₂O₄ and 70-30 wt % TiO₂.

3. The process according to claim 1, wherein the process further comprises:
i-1) a prior step for preparing the MgAl₂O₄ of said porous material by providing a starting material comprising MgAl₂O₄ and subjecting it to calcination in air at 850-1050° C.; or
i-2) providing a starting material directly as said MgAl₂O₄;
and/or
ii-2) a prior step for preparing the TiO₂ of said porous material by providing a starting material comprising TiO₂ and subjecting the starting material to calcination in air to below 500° C.; or
ii-2) providing a starting material directly as said TiO₂.

4. The process according to claim 1, wherein the titania (TiO₂) is at least 99.9 wt % anatase.

5. The process according to claim 1, wherein the porous material comprises one or more metals selected from Co, Mo, Ni, W, and combinations thereof; and the content of the one or more metals is 0.25-20 wt %.

6. The process according to claim 1, wherein the porous material has a BET-surface area of 1-150 m²/g.

7. The process according to claim 1, wherein the MgAl₂O₄ of the porous material is at least 90 wt % MgAl₂O₄, and has a pore size distribution (PSD) in which at least 60 vol. % of the total pore volume is in pores with a radius below 400 Å.

8. The process according to claim 1, wherein the TiO₂ of the porous material is at least 90 wt % TiO₂, and has a pore size distribution (PSD) in which at least 90 vol. % of the total pore volume is in pores with a radius below 120 Å; and wherein the average pore size radius is 80-100 Å.

9. The process according to claim 1, wherein the one or more metals comprise Mo and its content is 0.5-15 wt %.

10. The process according to claim 9, wherein the porous material is free of Co and/or W and further comprises 0.05-0.5 wt % Ni.

11. The process according to claim 1, wherein the one or more impurities are selected from a vanadium-containing impurity, silicon-containing impurity, a halide-containing impurity, an iron-containing impurity, a phosphorous-containing impurity, and combinations thereof; and further the process is carried out at high temperature such as 100-400° C., optionally in the presence of a reducing agent.

12. The process according to claim 1, wherein the feedstock is:
i) a renewable source obtained from a raw material of renewable origin, or a feedstock derived from one or more oxygenates taken from the group consisting of triglycerides, fatty acids, resin acids, ketones, aldehydes or alcohols where said oxygenates originate from one or more of a biological source, a gasification process, a pyrolysis process, Fischer-Tropsch synthesis, or methanol based synthesis; or
ii) a feedstock originating from a fossil fuel; or
iii) a feedstock originating from combining a renewable source according to i) and a feedstock originating from a fossil fuel according to ii).

13. The process according to claim 12, wherein the portion of the feedstock originating from a renewable source is 5-60 wt %.

14. The process according to claim 1, wherein the one or more impurities is a phosphorous (P)-containing impurity and said feedstock contains 0.5-1000 ppm P.

15. The process according to claim 1, wherein the purified feedstock is subsequently processed in a hydrotreatment stage in the presence of a hydrotreatment catalyst.

16. The process according to claim 1,
wherein the titania (TiO₂) is at least 99.9 wt % anatase, and
wherein the one or more impurities is a phosphorous (P)-containing impurity and said feedstock contains 0.5-1000 ppm P.
